(19) United States
(12) Patent Application Publication
(10) Pub. No.: US 2012/0194003 A1
(43) Pub. Date: Aug. 2, 2012

(54) BYPASS AND PROTECTION CIRCUIT FOR A SOLAR MODULE AND METHOD OF CONTROLLING A SOLAR MODULE

(75) Inventors: Heribert SCHMIDT, Freiburg (DE); Werner ROTH, Freiburg (DE)

(73) Assignee: Fraunhofer-Gesellschaft zur Foerderung der angewandten Forschung e.V., Munich (DE)

(21) Appl. No.: 13/402,992

(22) Filed: Feb. 23, 2012

Related U.S. Application Data
(63) Continuation of application No. PCT/EP2010/062419, filed on Aug. 25, 2010.

(30) Foreign Application Priority Data
Aug. 26, 2009 (DE) 102009038601.7
Oct. 19, 2009 (DE) 102009049922.9

(51) Int. Cl. H01H 35/00

(52) U.S. Cl. 307/116

(57) ABSTRACT

A bypass and protection circuit for a solar module includes an input for connecting the solar module, an output, a bypass element connected in parallel to the output, and a separating element connected between the input and the output and configured to control the connection between the input and the output. The separating element is configured to control a connection between the input and the output in dependence on whether the solar module associated with the circuit is completely or partially shaded, or whether the solar module associated with the circuit is to be switched on or off.

### CROSS-REFERENCE TO RELATED APPLICATIONS

This application is a continuation of copending International Application No. PCT/EP2010/062419, filed Aug. 25, 2010, which is incorporated herein by reference in its entirety, and additionally claims priority from German Applications Nos. DE 102009038601-7, filed Aug. 26, 2009, and DE 102009049922-9, filed Oct. 19, 2009, both of which are incorporated herein by reference in their entirety.

### BACKGROUND OF THE INVENTION

The present invention relates to the field of solar technology, and in particular to a bypass and protection circuit for a solar module as well as to a method of controlling a solar module bypassed by a bypass element.

In the operation of solar modules various situations occur wherein either the solar modules no longer work at the optimum operating point, or wherein damaging of the solar modules may occur due to internal or external conditions. Also, situations may arise wherein solar modules represent a danger to their environment.

In the event of a series connection of solar cells, in the event of inhomogenous illumination/partial shading or even in the event of different properties of the solar cells, in particular of the short-circuit current, the problem arises that, on the one hand, the cells in question determine the current flow in the overall circuit, and on the other hand, the voltage present at said cells will reverse, i.e. they will turn into load and in the worst case may be damaged. Irrespective of the actual cause of said voltage reversal, the terms “shading” or “shading event” will be used below. One known measure to avoid damaging consists in utilizing so-called bypass diodes, which generally are switched, within a solar module, in parallel to subgroups of, e.g., 16 to 24 crystalline solar cells. In normal operation, the bypass diodes are reverse-biased. In case of partial shading, the bypass diodes are forward-biased and take over the phase current caused by the non-shaded cells. In this case, the operating-point voltage across the segment in question of the solar generator decreases from the normal operation approx. +8 V to +12 V (while assuming an MPP voltage of 16 to 24 cells) to the forward voltage of the bypass diode, i.e. to approx. −0.4 V to −0.6 V.

The maximum current flowing through the bypass diode is dependent on the cell technology and the cell size, it being possible for the maximum current to amount to up to 8.5 A with silicon cells having surface areas of 156 mm×156 mm, as are common today. Because of larger cell surface areas and higher efficiency factors of the solar cells used, even higher currents in the range of more than 10 A are to be expected for the future.

The bypass diodes used are typically commercial silicon pn diodes, but also Schottky diodes, more recent developments also employing MOFETs as active bypass elements.

In normal operation, i.e. without any shading, the bypass diodes cause next to no losses since they are reverse-biased, and since only little reverse current flows through them. In the event of shading, however, all of the current caused by the modules that are connected in series and are not shaded may flow through the bypass diode. In accordance with their forward voltage and the current flowing through, a power dissipation of several watts per diode will result, which in the event that shading persists over a relatively long period of time will lead to intense heating of the component. Said heating will adversely affect the surrounding module components, such as the connecting box, the connecting cable or the modular structure, and in the worst case the components or the bypass diode themselves will be damaged.

DE 10 2005 036 153 B4 proposes replacing the diode with an active device, namely a low-resistance MOSFET, which will be activated in the event of shading. By this measure, any power dissipation that may still arise can be reduced by, e.g., a factor of 20 or more, which eliminates the above-mentioned problems of overheating. With this approach, the aim is to provide a circuit or a component which is terminal-compatible with conventional diodes, i.e. also has only two terminals. However, this leads to the problem that, in the event of shading, only the very low voltage dropping across the active bypass element will be available for driving the bypass element, so that in accordance with the teachings of DE 10 2005 036 153 B4, a charging circuit will additionally be provided which is arranged in connection with an isolating circuit so as to convert transduce the available voltage, which is within the range of millivolts, to a suitable control voltage in the range of 10 to 15 V. Thus, this approach involves a large amount of effort in terms of circuit engineering, in particular in connection with realizing the charging circuit, for example in the form of a choke or reverse transducer or in the implementation as a low-voltage charge pump. This renders realization of an active bypass and protection circuit as an integrated circuit more complicated and more expensive.

In addition, solar modules have the property that they will produce electric voltage as long as they are irradiated, which means that they cannot be switched off. This involves particular precautionary measures in installation and maintenance. What is also problematic is the often high solar generator voltage of several hundred volts in the event that a house having a solar generator mounted on its roof catches fire.

Commercial solar modules do not have the possibility of being switched off. The above-mentioned DE 10 2005 036 153 B4 suggests utilizing the active bypass element also for targeted switching off and/or switching on of the module via an external control signal. A further approach to switching off solar generators is proposed by the company Aixcon (www.aixcon.de) with the system “ebreak”, in accordance with which the entire solar generator will be short-circuited, in an emergency, via a single switch, for example a thyristor. However, this does not the solve the fundamental problem, since this approach only switches those lines into a voltage-free state which continue behind this unit, but a high voltage will again arise when the module connection on the roof is separated. The general possibility of disconnecting individual solar modules in a targeted manner by means of an external signal is also described in DE 10 2006 060 815 A1, which represents both short-circuiting of the solar modules and separating of the series connection without giving details of an implementation. The solution suggested here by using a series switch is disadvantageous since said series switch will be adapted to the maximum system voltage in terms of its voltage-sustaining capability, for example to up to 1000 V, since with a series connection of many modules it cannot be ensured that all of the switches will open synchronously. Such a switch is expensive and will invariably produce a large power dissipation due to its comparatively high on-resistance, and it will lead to the problems described above with regard to the heat generation and the risk of damage associated therewith. The solution using a parallel switch also exhibits the above-mentioned disadvantages of expensive provision of the supply voltage that may be used, and further has the disadvantage that short-circuit operation of the module will increase the likelihood of damage being caused by so-called “hotspots”.

The above-mentioned DE 10 2005 036 153 B4 of the applicant further mentions switching off of a solar module by a parallel switch.

### SUMMARY

According to an embodiment, bypass and protection circuit for a solar module in a series connection of a plurality of solar modules may have: an input for connecting the solar module; an output for connection with the series connection; a bypass element connected in parallel to the output; and a separating element connected between the input and the output and configured to control the connection between the input and the output; wherein the separating element is configured to control a connection between the input and the output in dependence on whether the solar module associated with the circuit is completely or partially shaded, or whether the solar module associated with the circuit is to be switched on or off.

According to another embodiment, a method of operating a solar module bypassed by a bypass element may have the steps of: determining whether the solar module is completely or partially shaded or whether switch-off of the solar module is desired; and if the solar module is determined to be completely or partially shaded, or if it is to be switched off, operating the solar module in an open-circuit condition, wherein the solar module is part of a series connection of a plurality of solar modules, said operating of the solar module in an open-circuit condition including separating the solar module from the series connection.

In accordance with an embodiment, the control signal causes an interruption of the normally closed connection between the input and the output when the solar module associated with the circuit is completely or partially shaded, or when the solar module associated with the circuit is to be switched off. Similarly, the circuit may be configured to cause a normally open connection between the input and the output to be established when the solar module associated with the circuit is to be switched on. In accordance with embodiments, the circuit may be coupled to the solar module such that an interruption of the connection by the separating element causes an open-circuit operation of the solar module.

The circuit may either comprise a control signal terminal for receiving the control signal, or the control signal may be received via an input and/or via the output of the circuit. In accordance with one embodiment, the circuit includes a controller operatively connected to the separating element and configured to create the control signal. In this case, the controller may have a power supply terminal connected to the input of the circuit. The controller may be configured to determine, on the basis of the power signals present at the input and at the output, whether the solar module associated with the bypass protection circuit is being partially or completely shaded, and to create the control signal if the solar module is determined to be completely or partially shaded. In this case, provisions may be made to drive the actual bypass element by a control signal as well, said control signal, too, being created by the controller if the solar module is determined to be completely or partially shaded. The controller may further be configured to check, once a completely or partially shaded state has been determined, whether the shading situation still persists, so as to cause switching back to the normal state if the shading situation no longer persists.

In accordance with one aspect of the invention, the control signal for establishing the normally open connection may be created externally and be provided to the circuit so as to switch on the solar module. Alternatively the control signal for interrupting the normally closed connection may be created on the basis of one or more signals from internal and/or external sensors in order to switch off the solar module.

The separating element may include a switch, for example a transistor or the like, and the bypass element may include a diode or a diode having a switch arranged in parallel.

Embodiments of the invention provide a method of controlling a solar module bridged/shunted by a bypass element, the method comprising:
determining whether the solar module is completely or partially shaded or whether switch-off of the solar module is desired; and
if the solar module is determined to be completely or partially shaded, or if it is to be switched off, operating the solar module in an open-circuit condition.

The solar module may be part of a series connection comprising a plurality of solar modules, operation of the solar module in an open-circuit condition including separating the solar module from the series connection. In addition, it may be determined, on the basis of the power signals at a terminal of the solar module and on the basis of the power signals at a terminal of the series connection, whether the solar module is being partially or completely shaded; in addition, provision may be made to check, once a state of partial or complete shading has been determined, whether said state still persists, so as to switch back to a normal state if need be.

Thus, embodiments of the present invention provide a desirable ability of a solar module to be switched off and/or switched on in a targeted manner via an external or internal control signal, autonomous switching off of the module upon recognition of inadmissible operating conditions also being enabled.

Embodiments of the invention provide a bypass and protection circuit for a solar module having at least one electric bypass element whose switching path is connected in parallel with the output terminals of the bypass and protection circuit, at least one controllable electrical switching element being connected in series with one of the interconnecting lines between the input terminals and the output terminals of the bypass and protection circuit, said controllable electrical switching element being able to be driven by a control circuit.

In accordance with this further aspect, a MOSFET may be employed as the switching element. In addition, the energy that may be used for supplying the control circuit may be provided from the associated solar module and/or from the voltage across the bypass element. In addition, an energy buffer may be provided for bridging short-term supply shortages. For the control circuit, a DC/DC converter may be provided for delivering a supply voltage. The bypass and protection circuit may distinguish, by means of a logic circuit, between the operating states of “normal” and “shading”, the switching element being switched on or off accordingly. In addition, the switch may be activated via an external control signal to switch the module on and off. A further, controllable switching element may be connected in parallel with the bypass element; said further switching element may be a MOSFET. The logic circuit for distinguishing between the above-mentioned operating states is further provided to switch both switching elements on or off accordingly. Likewise, the switches may be activated via an external control signal to switch the module on or off. The circuit may be implemented in the form of an integrated circuit.

Other embodiments of the invention provide a bypass and protection circuit for a solar module having at least one electric bypass element which is connected in parallel with the output terminals of the bypass and protection circuit and which may conduct the current generated by a further solar module connected in series with the solar module, or generated by a plurality of modules connected in series; a controllable electrical separating element which may be controlled by a control circuit is located in one or both interconnecting lines between the input terminals and the output terminals of the bypass and protection circuit.

In accordance with this yet further aspect, a transistor may be employed as the separating element, and the energy that may be used for supplying the controller may be provided from the associated solar cell arrangement and/or from the voltage across the bypass element. In addition, an energy buffer may be provided for supplying the controller. Similarly, a DC/DC converter may be provided for delivering a supply voltage of the controller. By means of a logic circuit, one may distinguish between the operating states of “normal” and “shading”, it being possible for the separating element to be switched on or off accordingly. In addition, the separating element may be activated via an external and/or internal control signal, and, thus, the module may be switched on or off. A diode may be employed as the bypass element, it being possible for a further controllable switching element to be connected in parallel with the bypass element. Alternatively, a switching element may be used as the bypass element, which switching element is a transistor, for example. In this case, the two switching elements are driven by the logic circuit or by an internal and/or external control signal to switch the module on or off. Again, the circuit may be implemented in the form of an integrated circuit.

### BRIEF DESCRIPTION OF THE DRAWINGS

Embodiments of the present invention will be detailed subsequently referring to the appended drawings, in which:

FIG. 1 shows a block diagram of a bypass and protection circuit in accordance with an embodiment of the invention;

FIG. 2 shows a bypass and protection circuit in accordance with an embodiment of the invention;

FIG. 3 shows a block diagram of a controller of the circuit of FIG. 2 in accordance with an embodiment of the invention;

FIG. 4 shows a bypass and protection circuit in accordance with a further embodiment of the invention;

FIG. 5 shows a block diagram of a controller of the circuit of FIG. 4 in accordance with a further embodiment of the invention; and

FIG. 6 shows a state diagram for explaining the mode of operation of the controllers of FIGS. 3 and 5 for determining whether a shaded state of a solar module persists.

### DETAILED DESCRIPTION OF THE INVENTION

In the following description of the embodiments of the invention, elements which are identical or have identical actions are provided with identical reference numerals.

Embodiments of the invention provide a bypass and protection circuit which
exploits the advantages of active switching elements for reducing the heat evolution in the event of shading and for optionally switching on solar modules in a targeted manner, but at the same time exhibits a clearly reduced effort involved in providing the control voltage that may be used internally,
operates the shaded solar cells in an open-circuit condition rather than in a short circuit,
is compatible with commercial system components, such as DC-AC inverters, and
may be realized with low-loss and inexpensive structural components having low voltage-sustaining capability.

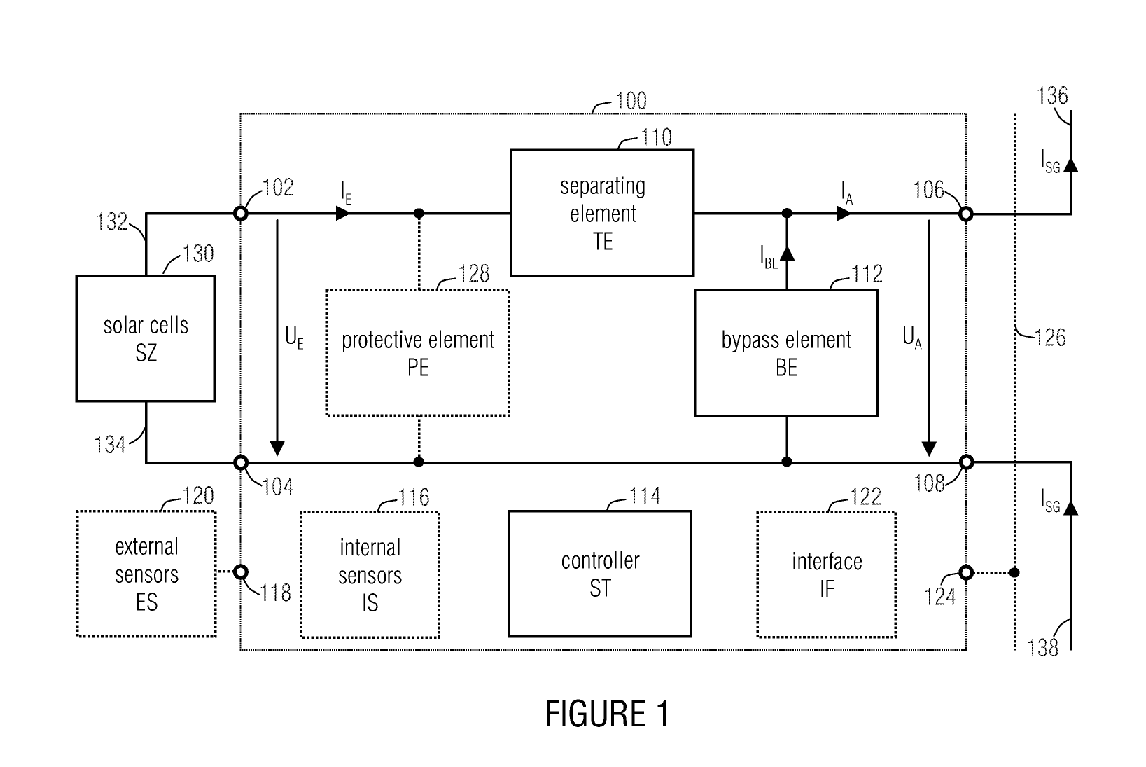

FIG. 1 shows a block diagram of a bypass and protection circuit 100 in accordance with an embodiment of the invention. The bypass and protection circuit 100 includes two input terminals 102 and 104 and two output terminals 106 and 108. A separating element (TE) 110 is connected between the first input terminal 102 and the first output terminal 106. A bypass element (BE) 112 is connected between the first output terminal 106 and the second output terminal 108. The bypass and control circuit may further include, in accordance with embodiments, a controller (ST) 114, which will be explained in more detail below. In addition, the circuit 100 may include one or more internal sensors (IS) 116 as well as a further terminal 118, which may be provided to receive signals from external sensors (ES) 120. In addition, an interface (IF) 122 may be provided. Additionally, a control terminal 124 may be provided for receiving an external control signal, which may be provided via an external control or communication line (conductor) 126. In addition to the separating element 110 and to the bypass element 112, a protective element (PE) 128 may be connected between the first input terminal 102 and the second input terminal 104. A solar cell arrangement (SZ) 130 is connectable to the circuit 100, a first terminal of the solar cell arrangement 130 being connectable to the first input terminal 102 via a first line 132, and a second terminal of the solar cell arrangement 130 being connectable to the second input terminal 104 of the circuit 100 via a second line 134. The first output terminal 106 of the circuit 100 is connected to a first terminal conductor 136, which leads to a further solar cell arrangement 130; here, too, a circuit 100 as is shown in FIG. 1 may be provided. The second output terminal 108 is connected to a second terminal conductor 138, which leads to a preceding solar cell arrangement, which may also have a protection circuit 100. In an alternative implementation of the circuit 100, the separating element 110 may also be arranged in the negative connection conductor between the second input terminal 104 and the second output terminal 108.

In the bypass and protection circuit 100 in accordance with FIG. 1, the solar cell arrangement 130 connected to the inputs 102, 104 via the two lines 132, 134 is separated from the output 106, 108 via the serial separating element 110 in the event of shading. The solar generator current I_{SG} impressed into the outer terminal conductors 136, 138 by the non-shaded modules connected in series with the shaded module will then continue to flow via the bypass element 112 arranged in parallel to the output terminals 106, 108. Unlike in conventional technology, the shaded solar cells are thus in an open circuit and are protected against being damaged due to an overload (hotspots). This mode of operation further enables increasing the number of solar cells which are connected in series and belong to a bypass and protection circuit from currently about 16 to 24 cells; as a result, fewer bypass and protection circuits may be used in total, and module manufacturing is simplified since fewer taps may be used at the cells connected in series within the module.

In the bypass and protection circuit 100 in accordance with FIG. 1, the voltage that may be used for supplying the controller 114 may advantageously be obtained from the input voltage U_{E} of the shaded solar cell arrangement 130 rather than—as is customary in conventional technology—from the very low voltage U_{A} across the bypass element 112. In this context, use is made of the solar cell's property consisting in that the available current indeed decreases heavily in the event of shading, but the open-circuit voltage or the voltage at low load nearly corresponds, given a low load, to the voltage of a non-shaded cell even in the event of extreme shading. Optionally, the supply voltage for the control circuit 114 may also be obtained from the voltage U_{A} across the bypass element 112 in accordance with the approaches from conventional technology, or from both sources.

As compared to the concept indicated in DE 10 2006 060 816 A1, the bypass circuit in accordance with embodiments of the invention is advantageous since what may occur, as a maximum, across the serial separating element 110 in the reverse direction is the open-circuit voltage output by the associated solar cell arrangement 130, which is why low-resistance, low-loss and inexpensive switching elements may be employed for implementing the separating element 110. In addition to the main functional groups mentioned so far, namely the separating element 110, the bypass element 112 and the controller 114, the bypass and protection circuit 100 may optionally comprise further assemblies which are depicted in dotted lines in FIG. 1. The input 102, 104 may be protected against voltage reversal or overvoltage by the protective element 128. The controller 114 may further be connected to the internal or external sensors 116 and/or 120, i.e. for sensing the temperature of the circuit itself or of the solar cell arrangement or its environment. Via the interface 122, uni- or bidirectional communication may exist between the circuit and further components of the photovoltaic installation. This communication may be effected via a power line communication (PLC) via conductors 136, 138, or via the additional communication line 126. The circuit may include further assemblies serving, e.g., to protect individual structural components of the circuit against overvoltage; however, they are not depicted for reasons of clarity.

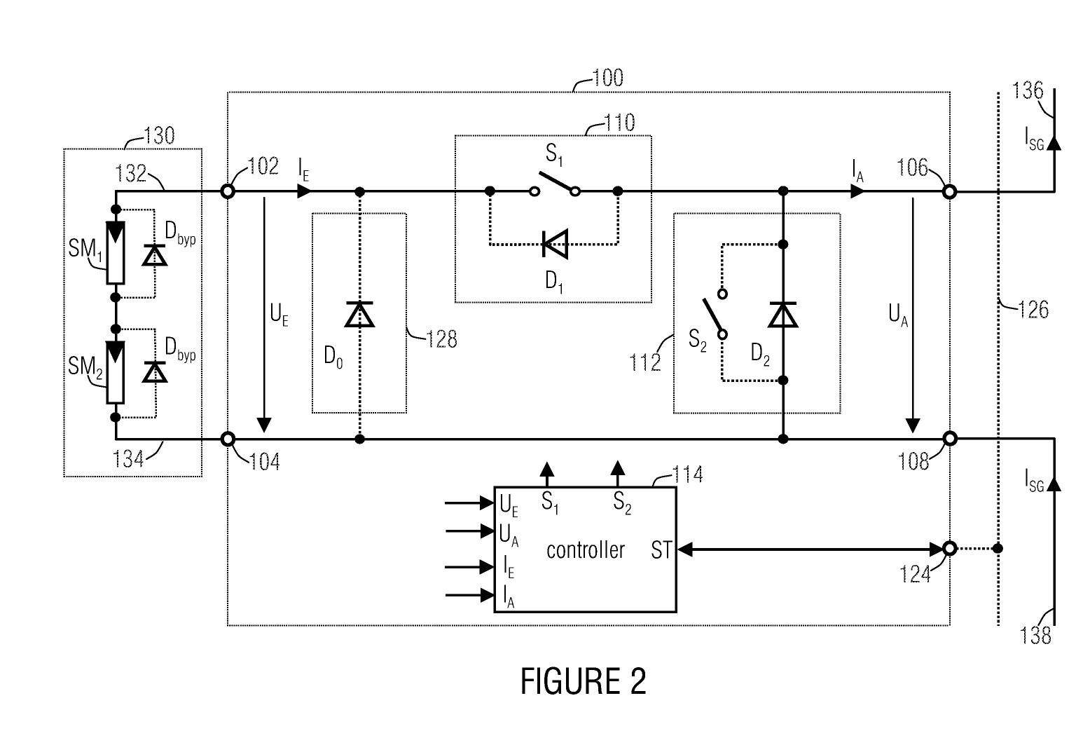

FIG. 2 shows a bypass and protection circuit in accordance with an embodiment of the invention. In the embodiment shown in FIG. 2, the separating element 110 is implemented by a parallel connection consisting of a switch S₁ and a diode D₁. The bypass element is likewise implemented by a parallel connection consisting of a switch S₂ and a diode D₂. The protective element 128 is implemented in the form of a diode D₀. The controller 114 receives the voltage U_{E} at an input. In addition, the controller 114 receives a control signal ST, which is provided to the circuit 100 via the communication line 126 and the control terminal 124, and the output voltage U_{A}. The controller provides corresponding signals for driving the switches S₁ and S₂. In the circuit 100 in accordance with FIG. 2, the voltage that may be used for supplying the control voltage 114 and for driving the active switch elements Sₛ and S₂ is no longer obtained from the very low voltage U_{A} across the bypass element 112, but from the input voltage U_{E} of the switched-off solar module 130. As was mentioned above, use is made, in this context, of the solar cell's property consisting in that the current indeed decreases heavily in the event of shading, but the open-circuit voltage or the voltage at low load nearly corresponds, given a low load, to the voltage of a non-shaded cell even in the event of extreme shading. Therefore, in the circuit 100, in the event of shading, the sub-generator (SM) 130 in question is separated from the series connection of the modules via the series switch S₁ and is thus operated in an open-circuit condition, except for a minimum internal power consumption of the controller 114. The solar generator current I_{SG} impressed by the non-shaded modules which are connected in series with the shaded modules continues to flow via the diode D₂, which thus basically acts as a conventional bypass diode. At the same time, the shaded solar cells are almost in the open-circuit condition and are thus protected against damage (hotspots).

With solar modules having low currents, the dissipation heat arising in the diode D₂ on account of its forward voltage is tolerable. In the event of relatively high current strengths, however, the above-mentioned problem of overheating may occur. This is solved in that the low-resistance switch S₂ is connected in parallel with the diode D₂. Upon occurrence of partial shading, said low-resistance switch S₂ is switched on in accordance with a strategy which will be explained by way of example below and takes over the solar generator current I_{SG}. In accordance with the forward resistance of the switch S₂, only a minimal heat evolution will then occur. As compared to the above-described prior art in accordance with DE 10 2005 036 153 B4, the low expenditure involved for providing the supply voltage for the controller 114 is advantageous. As has been mentioned above, however, the supply voltage may optionally also be obtained, similarly to conventional technology, from the voltage U_{A} across the bypass element D₂ and/or S₂. In an alternative implementation of the circuit 100 in accordance with FIG. 2, the series switch S₁ may also be located in the negative connection conductor between the second input terminal 104 and the second output terminal 108. The diode D₁ protecting the switch S₁ against negative reverse voltages may be connected in parallel with the switch S₁. Optionally, the diode D₀ may be provided as an additional protective measure against negative module voltages. Further, optional protective elements, e.g. acting against overvoltages at the inputs and outputs of the bypass and protection circuit or at the switching elements themselves are not depicted for reasons of clarity.

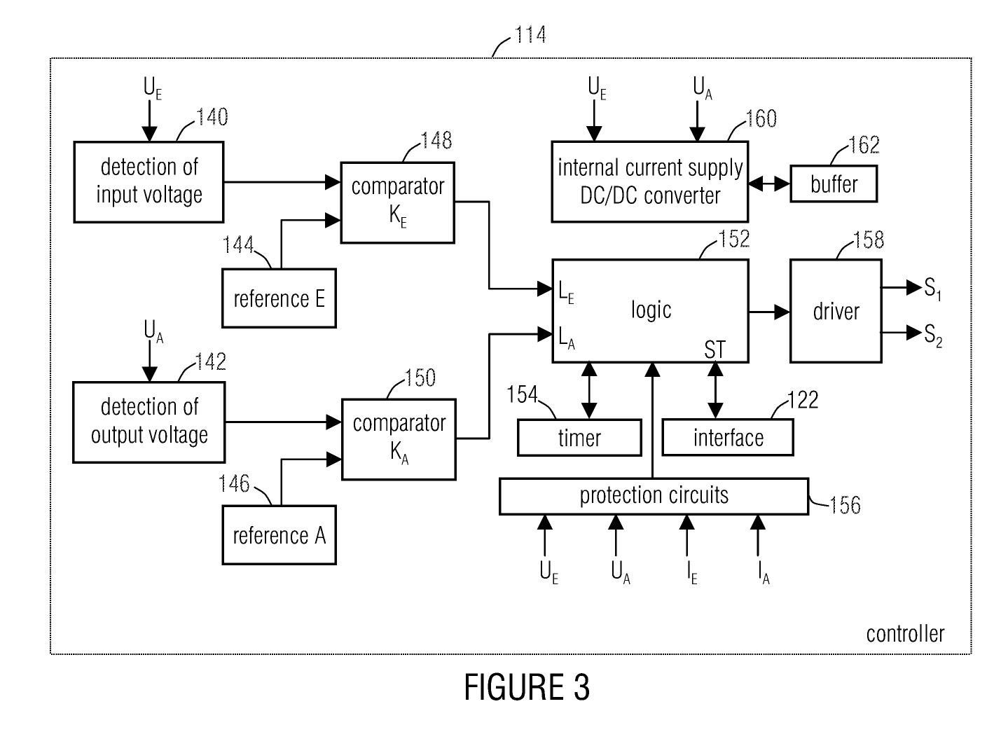

FIG. 3 shows a block diagram of the controller 114 of the circuit of FIG. 2 in accordance with an embodiment of the invention. As may be seen, the controller 114 includes a first block 140, which receives and measures the input voltage U_{E}. In addition, the controller 114 includes a block 142, which receives and measures the output voltage U_{A}. In addition, the controller 114 includes a first reference voltage source (E) 144 and a second reference voltage source (A) 146. In addition, a first comparator 148 and a second comparator 150 are provided. The first comparator (K_{E}) 148 receives the input voltage U_{E} measured by the U_{E} block 140 and the reference voltage from the reference voltage source 144, and outputs a signal L_{E} to a logic circuit 152. The comparator 150 receives the output voltage signal measured by the U_{A} block 142 as well as the reference voltage signal from the reference voltage source 146, and outputs the comparator output signal L_{A} to the logic circuit 152. In addition, the logic 152 receives a timer signal from a timer 154 and a control signal ST from the interface 122. Via protection circuits 156, the logic 152 receives signals indicating the input voltage U_{E}, the output voltage U_{A}, the input current I_{E}, and the output current I_{A}. The logic 152 includes, via a driver 158, the drive signals S₁ and S₂ for driving the switching elements S₁ and S₂ of the separating element 110 and of the bypass element 112. The controller 114 further includes an internal current supply 160, which may have a DC/DC converter. The internal current supply 160 receives the input voltage U_{E} and/or the output voltage U_{A}. The current supply 160 is further coupled to a buffer 162, for example a capacitor or the like, so as to provide energy even in times when there is no external energy available.

The controller 114 includes the two input blocks 140 and 142 with which both the input voltage U_{E} (the voltage of the solar module SM) and the output voltage U_{A} (the voltage across the bypass path S₂, D₂—FIG. 2) are measured. Both voltages are compared to the reference values E and A, respectively, by means of the comparators 148 and 150. The logical output signals L_{E}, L_{A} of the comparators 148 and 150 will be “1” if the respective measurement voltage is above the reference value. Both switching signals are linked with each other in the logic circuit 152, said circuit communicating with the timer circuit 150, the protection circuits 156 against overcurrents and overvoltages and, optionally, with a communication interface 122, so that both switches S₁ and S₂ may be driven via the driver circuits 158. The controller 114 is supplied from the input voltage by means of the internal current supply 160, which may have a direct current converter (DC-DC converter, e.g. charge pump), but may be designed to be clearly more simple, due to the comparatively high supply voltage U_{E}, than in conventional technology. In addition, the current supply may have an energy store 162 for bridging transient supply shortages. Optionally, the supply voltage may also be obtained, in accordance with conventional technology, from the voltage U_{A} across the bypass element in the event of a switch-off.

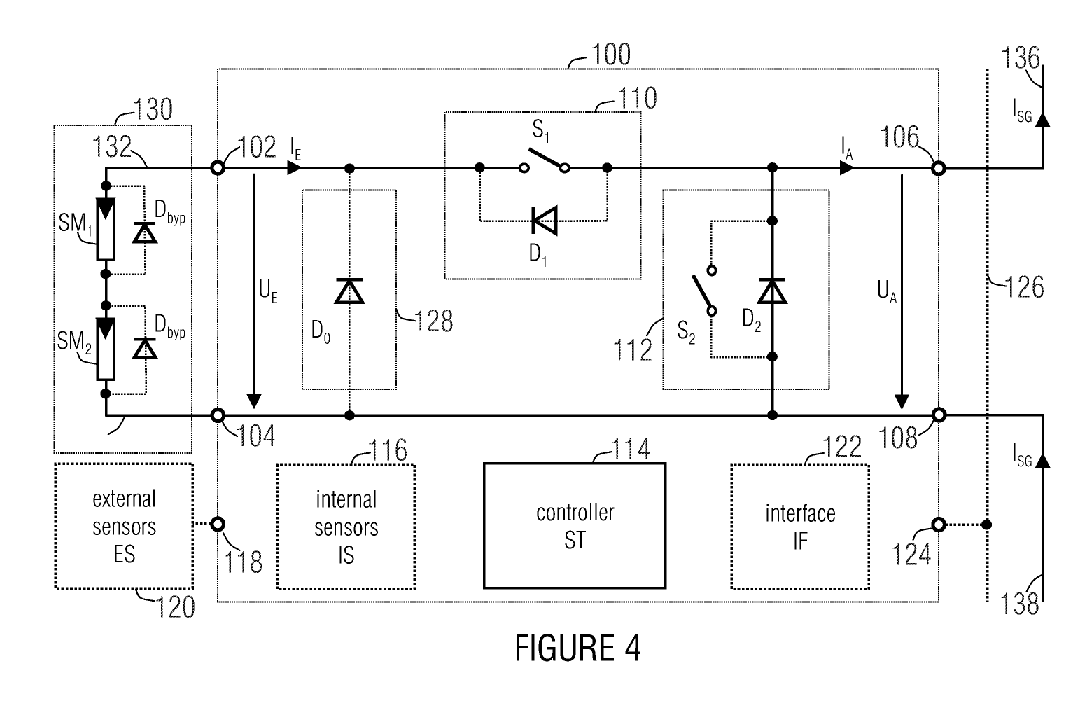

A further embodiment of the invention will be explained below with reference to FIG. 4. FIG. 4 shows a bypass and protection circuit in accordance with an embodiment of the invention, the implementations of the separating element 110, of the bypass element 112 and of the protective element 128 corresponding to those described with reference to FIG. 2. The circuit 100 further includes the internal sensors 116, the interface 122 and the terminal 118 so as to receive signals from the external sensors 120. The solar cell arrangement 130 includes two solar modules SM₁ and SM₂, each of which is bridged via associated diodes D_{BYP}. The mode of operation of the circuit 100 of FIG. 4 corresponds to the mode of operation of the circuit of FIG. 2, so that repeated description of same will be dispensed with here, reference being made to the above explanations instead.

In accordance with an alternative embodiment, in the circuit of FIG. 4, it is possible to exclusively use the switch S₂, which is controlled in the manner described below, as the bypass element. Relays, but advantageously semiconductor devices, may be employed as the switching elements S₁ and S₂. In this context, both normally-off and normally-on devices may be employed. Utilization of a normally-on device as the switch S₂ entails the advantage of a “fail-safe” behavior, i.e. in the event of failure of the controller 114, the switch S₂ would short-circuit the output of the bypass and protection circuit and would therefore switch it into a voltage-free state.

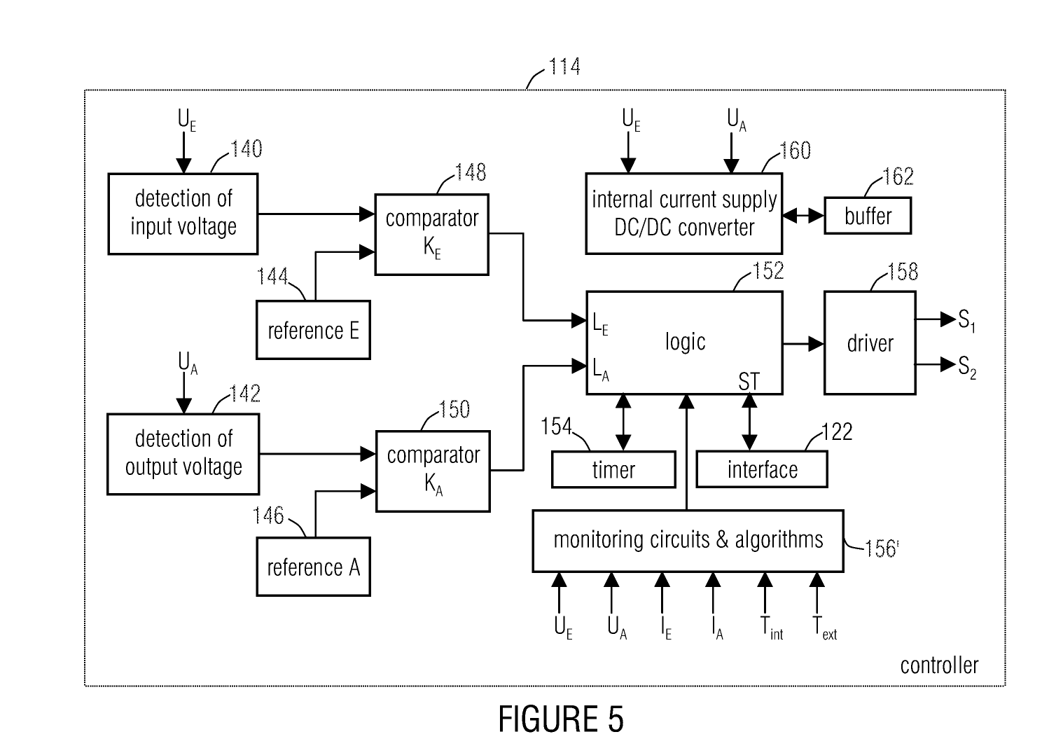

FIG. 5 shows a block diagram of the controller 114 of FIG. 4, the design of the controller of FIG. 5 essentially corresponding to the design of the controller of FIG. 3; however, instead of the protection circuits 156 in FIG. 3, a block 156′ is indicated which contains monitoring circuits and algorithms, which further receives temperature signals Tᵢₙₜ and Tₑₓₜ indicating internal and external temperatures. The internal current supply 160 may further include stabilization circuits.

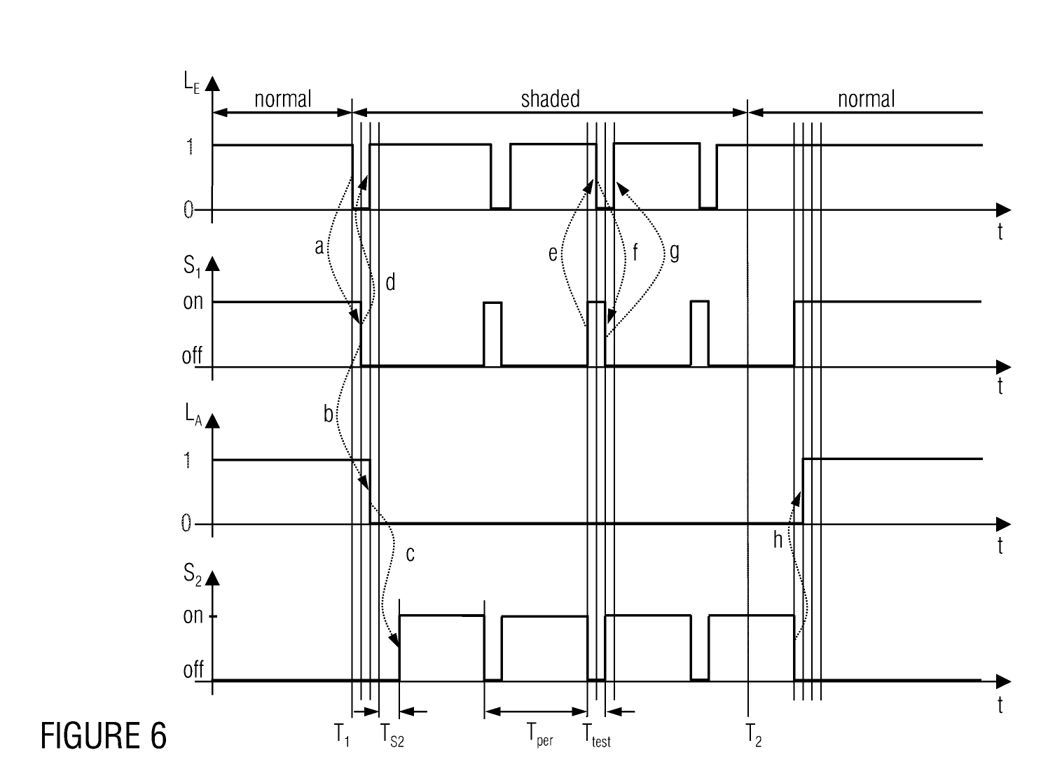

The functionalities of the controllers in accordance with FIGS. 3 and 5 for driving the switches S₁ and S₂ will be explained below in more detail with reference to FIG. 6; in particular, a description will be given of how one determines whether a shaded state of the solar module still persists. The following description relates to the embodiment of FIGS. 2 and 4 comprising an additional switchable electrical bypass path via the switch S₂, but may basically also be applied to the variant without the switch S₂ or to the variant without the diode D₂.

As was explained above, in the event of shading, the series switch S₁ is opened and the optional parallel switch S₂ is closed. Once the shading situation has been eliminated, said operating state would permanently persist if no particular measures were taken. Thus, one has to check whether activating the bypass function still makes sense, and one will select the switch positions of S₁ and S₂ accordingly. In accordance with embodiments of the invention, this may be effected by creating, on a short-term basis, specific constellations of the switches S₁ and S₂ and by means of an evaluation of the voltages and currents occurring at the terminals or within the bypass and protection circuit.

This is effected via the controllers 114, which are depicted by means of FIGS. 3 and 4 and whose functionalities will be explained below with reference to FIG. 6, which as a state diagram shows the temporal connections between the comparator signal L_{E}, the switching signal S₁, the comparator signal L_{A}, and the switching signal S₂. FIG. 6 represents both normal operation without shading, operation with shading and operation following a transition from shading to normal operation.

In normal operation, both the input voltage and the output voltage are above the two reference values E and A, so that both comparator signals are at a logical “1”. Accordingly, the logic circuit 152 causes the switch S₁ to be switches on and the switch S₂ to be switched off. The input current I_{E} generated by the solar cell arrangement 130 is forwarded to the output 106, 108 via the low-resistance switch S₁ in an almost loss-free manner.

Shading occurs at a time T₁. The voltage across the module in question initially collapses until the reference value E of, e.g., +3 V is reached. The signal L_{E} changes from a logical “1” to “0”. Via the logic circuit 152, the switch S₁ is opened following a short, circuit-induced delay time, which is represented by the arrow “a”. The solar generator current I_{SG} impressed from outside is momentarily taken over by the diode D₂, as a result of which the output voltage U_{A} changes its sign and is limited to the forward voltage of, e.g., −0.4 V to −0.6 V of the diode D₂. Subsequently, the reference value A of the comparator K_{A} of, e.g., +0.1 V is fallen below, and its output signal L_{A} also changes from logical “1” to “0” following a short delay time, which is depicted by the arrow “b”. This will result in the bypass element S₂ being switched on either immediately or once a delay time T_{S2} has passed, which bypass element S₂ will then take over the current I_{SG} and produce almost no dissipation heat in the process. The delay time T_{S2} may be set to prevent the described switch-on operation of the switch S₂ in the event of short partial shading, e.g. when a bird flies over the installation.

As was set forth at the outset, opening of the switch S₁ results in a renewed fast increase in the voltage U_{E} to values of several volts, so that, on the one hand, the output signal L_{E} of the comparator K_{E} again takes on a logical “1” (see arrow “d”) and, on the other hand, the supply of the controller 114 is permanently ensured. The supply of the circuit may be from the energy buffer 162, which is configured as a capacitor, for example, during the switching operations described.

The stable state of the arrangement which occurs following shading would also persist once the shading is eliminated. Therefore, one will have to check to see whether or not the shading situation still persists, and one will have to adapt the switch positions accordingly. In one embodiment, the logic circuit 152, while using the timer circuit (timer) 154, causes the switch S₂ to be periodically opened, with a period duration Tₚₑᵣ, for a duration Tₜₑₛₜ, and the switch S₁ to be closed at the same time. If a shading situation persists (the current I_{SG} impressed from outside is larger than the input current I_{E} generated by the solar cell arrangement 130 in question), the old constellation will re-establish itself following this test pulse, which is represented by way of example in the central portion of FIG. 6. In accordance with embodiments, the period duration Tₚₑᵣ is selected to be clearly larger (e.g. by a factor of 5 or more) than the duration of the test pulse Tₜₑₛₜ, so that the average power dissipation in the diode D₂ remains small.

In FIG. 6, shading is eliminated at the time T₂. Accordingly, at the next test pulse, the input voltage will no longer collapse, the signal L_{E} will remain at a logical “1”, and the switch S₁ will also remain switched on. The output voltage U_{A} will exceed the reference value A, so that the signal L_{A} will also change to a logical “1”, and the switch S₂ will remain opened, so that the stable normal operation is achieved once again.

The bypass and protection circuits described in accordance with the embodiments of the invention may simply be realized as integrated circuits, since no expensive DC/DC converter circuits are required. They may be accommodated within a small volume and therefore be laminated into the solar module itself. However, the circuits may also be built into the module terminal box or be coupled, as an external structural unit, with conventional modules. As is shown in FIG. 4, the solar cells/solar modules connected to the bypass and protection circuit may again have bypass diodes D_{BYP}, which may be configured as conventional diodes or as active circuits.

The bypass and protection circuit in accordance with embodiments of the invention may be extended in a simple manner such that the module 130 may be switched on in a targeted manner via an external control signal ST, which is transmitted either via the terminal conductors 136, 138 (power line transmission) or via the additional communication line 126 or even—in a wireless manner—per radio or via magnetic fields. In this context, the switch S₁, which is open in the non-switched-on state, is closed. In the non-switched-on state, the switch S₂ may be either permanently opened or, optionally, closed, and will be driven in accordance with the strategy presented above once the module is activated. Switching on the modules in a targeted manner via a control signal may be exploited for safe installation or maintenance, for switching off in the event of a fire, or—with switch-on signals coded accordingly—for theft protection. The communication interface 122 may also be configured bidirectionally so as to transmit status signals from the solar module to external evaluation devices.

The module may also be switched off, within the circuit, by means of the internal and/or external sensors. This includes switch-off in the event of an overcurrent or an overvoltage, in the event of an excessive temperature Tᵢₙₜ of the circuit itself, or Tₑₓₜ of the module or its environment, or detection of inadmissible operating conditions such as interruptions or loose contacts within the solar generator, for example.

In accordance with embodiments of the invention, bypass and protection circuits for small currents may be realized without the switch S₂, since in this case the function of the active bypass switch S₂ is not absolutely necessary in order to reduce the heat evolution, the bypass diode D₂ being sufficient. This results in cost savings; the protective function as well as the possibility of switching the module on and off in a targeted manner via the signals obtained externally or internally are maintained.

In the embodiments described, the bypass element includes a parallel connection consisting of a switch S₂ and a diode D₂. As is described, for example, in DE 10 2005 036 153 B4, an active bypass diode may alternatively be used which is not operated as a switch. The supply voltage is obtained exclusively from the (low) voltage across the bypass element, the bypass element (MOSFET) being permanently maintained in a linear operation (at, e.g., a voltage of 50 mV across the MOSFET) via a regulating circuit.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example. Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A bypass and protection circuit for a solar module in a series connection of a plurality of solar modules, comprising:
an input for connecting the solar module;
an output for connection with the series connection;
a bypass element connected in parallel to the output; and
a separating element connected between the input and the output and configured to control the connection between the input and the output;
wherein the separating element is configured to control a connection between the input and the output in dependence on whether the solar module associated with the circuit is completely or partially shaded, or whether the solar module associated with the circuit is to be switched on or off.

2. The bypass and protection circuit as claimed in claim 1, wherein the separating element is configured to receive a control signal, said control signal
causing an interruption of the normally closed connection between the input and the output when the solar module associated with the circuit is completely or partially shaded, or
causing an interruption of the normally closed connection between the input and the output when the solar module associated with the circuit is to be switched off, or
causing the normally open connection between the input and the output to be established when the solar module associated with the circuit is to be switched on.

3. The bypass and protection circuit as claimed in claim 1, which may be coupled to the solar module such that an interruption of the connection between the input and the output by the separating element causes an open-circuit operation of the solar module.

4. The bypass and protection circuit as claimed in claim 2, comprising a control signal terminal which is operatively connected to the separating element and configured to receive the control signal.

5. The bypass and protection circuit as claimed in claim 2, wherein the input and/or the output is configured to receive the control signal.

6. The bypass and protection circuit as claimed in claim 2, comprising a controller operatively connected to the separating element and configured to create the control signal.

7. The bypass and protection circuit as claimed in claim 6, wherein the controller comprises a power supply terminal connected to the input and/or with the output.

8. The bypass and protection circuit as claimed in claim 6, wherein the controller is configured to determine, on the basis of the power signals present at the input and at the output, whether or not the solar module associated with the circuit is being partially or completely shaded, and to create the control signal if the solar module associated with the circuit is determined to be completely or partially shaded.

9. The bypass and protection circuit as claimed in claim 8, wherein the bypass element is configured to be driven by a further control signal, the controller being configured to create the further control signal if the solar module associated with the circuit is determined to be completely or partially shaded.

10. The bypass and protection circuit as claimed in claim 6, wherein the controller is configured to check, once the solar module associated with the circuit has been determined to be completely or partially shaded, whether the shading situation persists, and to switch to the normal state if it is determined that the shading situation no longer persists.

11. The bypass and protection circuit as claimed in claim 2, wherein the control signal for establishing the normally open connection between the input and the output is created externally and provided to the circuit so as to switch on the solar module, and/or the control signal for interrupting the normally closed connection between the input and the output is created on the basis of one or more signals from internal and/or external sensors in order to switch off the solar module.

12. The bypass and protection circuit as claimed in claim 1, wherein the separating element comprises a switch, and/or wherein the bypass element comprises a diode or a diode comprising a switch arranged in parallel.

13. A method of operating a solar module bypassed by a bypass element, the method comprising:
determining whether the solar module is completely or partially shaded or whether switch-off of the solar module is desired; and
if the solar module is determined to be completely or partially shaded, or if it is to be switched off, operating the solar module in an open-circuit condition,
wherein the solar module is part of a series connection of a plurality of solar modules, said operating of the solar module in an open-circuit condition comprising separating the solar module from the series connection.

14. The method as claimed in claim 13, wherein it is determined, on the basis of power signals at a terminal of the solar module and on the basis of power signals at a terminal of the series connection, whether the solar module is being partially or completely shaded.

15. The method as claimed in claim 13, wherein once the solar module has been determined to be completely or partially shaded, a check is performed to see whether the shading situation persists, and switching to the normal state is performed if it is determined that the shading situation no longer persists.
